(19) United States
(12) Patent Application Publication
(10) Pub. No.: US 2004/0225040 A1
(43) Pub. Date: Nov. 11, 2004

(54) Flame retardant-nanocomposite combination for thermoplastic polymers

(75) Inventor: Sebastian Hoerold, Diedorf (DE)

Correspondence Address: Clariant Corporation, Industrial Property Department, 4000 Monroe Road, Charlotte, NC, 28205, US

(73) Assignee: Clariant GmbH

(21) Appl. No.: 10/840,163

(22) Filed: May 6, 2004

(30) Foreign Application Priority Data
May 8, 2003 (DE) 103 20 465.2

(51) Int. Cl. C09K 21/00; C08K 5/34; C08K 3/34

(52) U.S. Cl. 524/115; 524/445; 252/609

(57) ABSTRACT

The invention relates to a novel flame retardant-nanofiller combination for thermoplastic polymers, which comprises, as component A, a phosphinic salt of the formula (I) and/or a diphosphinic salt of the formula (II) and/or polymers of these,

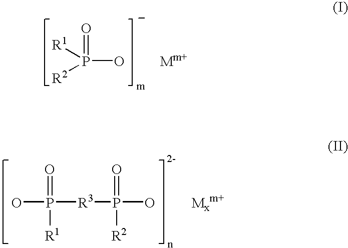

where

R¹, R² are identical or different and are C₁-C₆-alkyl, linear or branched, and/or aryl;

R³ is C₁-C₁₀-alkylene, linear or branched, C₆-C₁₀-arylene, -alkylarylene or -arylalkylene; M is Mg, Ca, Al, Sb, Sn, Ge, Ti, Zn, Fe, Zr, Ce, Bi and/or Mn;

m is 1 to 4;

n is 1 to 4;

x is 1 to 4, and comprises, as component B, condensation products of melamine, and/or reaction products of melamine with phosphoric acid or polyphosphoric acid, and/or comprises reaction products of condensation products of melamine with phosphoric acid or polyphosphoric acid, and/or comprises a mixture of these, and/or comprises, as component C, organic intercalated phyllosilicates, a nanospherical oxide, or carbon nanotubes.

The invention relates to a flame retardant-nanocomposite combination for thermoplastic polymers, and also to polymeric molding compositions which comprise these flame retardant-nanocomposite combinations.

The typical layer thickness of nanocomposites is thinner by a factor of from 10 to 50 than that of conventional lamellar fillers, such as kaolin, talc, or mica. The diameter of the fully exfoliated nanofillers varies from 100 to 500 nm for a layer thickness of only 1 nm.

The high level of particle fineness and the remarkable length-to-thickness ratio of above 100 are responsible for exceptional improvements in properties being achieved in a number of polymer materials, even at low filler concentrations in the region of a few percent by weight. Improvements may be made in particular in the mechanical, thermal, and barrier properties of thermoplastics. Flame retardancy can be improved through the formation of three-dimensional networks.

In preparing nanocomposites, it is preferable to use fillers based on aluminum silicates. These fillers have a layered structure. In the phyllosilicate sodium montmorillonite, there are sodium ions and water between the layers, and the distance between the individual layers is from 1-2 nm. When the sodium ions are exchanged for organic ions, especially quatemary organic ammonium compounds, the result is fillers with markedly larger layer separations of from 2-3 nm. These fillers are termed organoclays or nanofillers in the literature.

Polymer-nanofiller composites (nanocomposites) may be prepared by in situ polymerization of a monomer within the layers of the appropriately modiflied phyllosilicate. The monomer which penetrates the layers of the silicate here may be in solution or may be solvent-free. The polymerization may be initiated by suitable initiators, the location of which must likewise be within the layers.

Nanocomposites can be prepared using relatively simple technology, by extrusion. Here nanofillers and polymer are mixed in the melt. Given sufficient compatibility between polymer and phyllosilicate, the polymer can penetrate into the layers.

If complete or partial dispersion of the layers of the nanofiller occurs during the preparation of the nanocomposites, two different structures are possible:

in the case of intercalated structures, there are polymer chains between the silicate layers

in the case of exfoliated structures, there is complete and homogeneous distribution of the individual silicate layers within the polymer matrix.

Mixtures of the two structures are also possible.

Nanocomposites give exceptional improvements in properties due to their particular structure, inter alia an increase in stiffness, an improvement in impact strength, in thermal stability, and in flame retardancy (Beyer, G., Nanocomposites, ein neuartiges Flammschutzsystem [Nanocomposites, a novel flame retardant system], “Kunststoffe, Brandschutz und Flammschutzmittel” Technical Conference, Nov. 28-29, 2001 in Wurzburg).

Because the use of nanofillers as sole flame retardant cannot achieve sufficient flame retardancy, the literature describes attempts to combined nanofillers with other flame retardants.

DE 199 21 472 A1 describes a flame-retardant polymer composition which is composed of polymer, magnesium hydroxide or aluminum hydroxide, and organically intercalated phyllosilicate.

PCT/WO 99/29767 describes the preparation of a polyamide nanocomposite mixture composed of nylon-6, water, and montmorillonite. The addition of the nanofiller has an advantageous effect on heat distortion resistance. No flame-retardant action is described.

EP-0 132 228 A1 describes flame-retardant reinforced polyester molding compositions with reinforcing fillers (preferably glass fibers), with flame retardants from 0.2 to 4% of a phyllosilicate, where appropriate organically modified, as anti-drip agent, and from 0.05 to 2% of an alkali metal salt of a monocarboxylic acid having from 6 to 22 carbon atoms. The flame-retardant additives described comprise organic halogen compounds, in particular bromine compounds or chlorine compounds, alone or with synergistically active compounds of phosphorus or of antimony.

Surprisingly it has been found that the flame-retardant action of certain organophosphorus flame retardants can be considerably improved by adding nanofillers.

Large amounts of flame retardants often have to be added in order to give the plastic adequate flame retardancy complying with international standards. The chemical reactivity of flame retardants, which is required for flame-retardant action at high temperatures, can result in impairment of the processing stability of plastics. By way of example, the result can be increased polymer degradation, crosslinking reactions, evolution of gases, or discoloration. When plastics are processed without flame retardant, some of these effects do not occur at all, or occur only to a reduced extent. Use of the inventive combination-of flame retardant with nanocomposites permits the amount of flame retardant added to be markedly reduced, the result being improved processing of the plastics.

Particularly for thermoplastic polymers, the salts of phosphinic acids (phosphinates) have proven to be effective flame-retardant additives (DE-A-2 252 258 and DE-A-2 447 727). Calcium phosphinates and aluminum phosphinates have been described as particularly effective in polyesters, and, when compared with, for example, the alkali metal salts, result in less impairment of the properties of the polymer molding composition materials (EP-A-0 699 708).

Synergistic combinations of phosphinates with certain nitrogen-containing compounds have moreover been found, and have more effective flame-retardant action than the phosphinates alone in very many polymers (PCT/EP97/01664, and also DE-A-197 34 437 and DE-A-197 37 727).

Carbodiimides, isocyanates, and isocyanurates have proven effective for stabilizing polymer molding compositions with phosphorus-containing flame retardants (DE-A-199 20 276).

DE-A-196 14 424 describes phosphinates in combination with nitrogen synergists in polyesters and in polyamides. DE-A-199 33 901 describes phosphinates in combination with melamine polyphosphate as flame retardant for polyesters and polyamides. The action of the phosphinates and of the nitrogen synergists is in essence described for fire tests in compliance with the UL 94 vertical test. However, the action remains inadequate in the IEC flow-wire test. The additions needed for the UL 94 test also lead to polymer degradation and discoloration of the flame-retardant plastics, and no effective method has yet been found to counter this.

It was therefore an object of the present invention to provide flame retardant combinations for polyamides or polyesters which not only comply with various standards demanded in the electrical and electronics sector but also exert a stabilizing action on the plastic. This object is achieved by adding nanofillers, where appropriate together with nitrogen-containing synergists, as flame retardant.

The invention therefore provides a flame retardant-nanofiller combination for thermoplastic polymers, which comprises, as component A, a phosphinic salt of the formula (I) and/or a diphosphinic salt of the formula (II) and/or polymers of these,

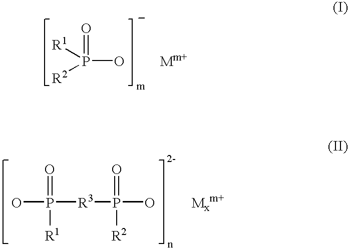

where

R¹, R² are identical or different and are C₁-C₆-alkyl, linear or branched, and/or aryl;

R³ is C₁-C₁₀-alkylene, linear or branched, C₆-C₁₀-arylene,

-alkylarylene or

-arylalkylene;

M is Al, Sb, Sn, Ge, Ti, Zn, Fe, Zr, Ce, Bi and/or Mn;

m is 1 to 4;

n is 1 to 4;

x is 1 to 4,

and comprises, as component B, condensation products of melamine, and/or reaction products of melamine with phosphoric acid or polyphosphoric acid, and/or comprises reaction products of condensation products of melamine with phosphoric acid or polyphosphoric acid, and/or comprises a mixture of these, and/or comprises, as component C, organic intercalated phyllosilicates, a nanospherical oxide, or carbon nanotubes.

Component C preferably comprises a silicate which contains residues of bentonite or montmorillonite, modified with a quaternary organic ammonium cation.

Surprisingly, it has been found that inventive combinations of phosphinates and nitrogen synergists, such as melamine polyphosphate, exhibit markedly improved stability on incorporation into polymers if certain nanofillers are added.

The inventive combinations reduce the discoloration of the plastics on processing in the melt and suppress the degradation of the plastics to give units with lower molecular weight. They also improve fire performance.

M is preferably calcium, aluminum, or zinc.

Protonated nitrogen bases are preferably the protonated bases of ammonia, melamine, triethanolamine, in particular NH₄+.

R¹ and R², identical or different, are preferably C₁-C₆-alkyl, linear or branched, and/or phenyl.

R¹ and R², identical or different, are particularly preferably methyl, ethyl, n-propyl, isopropyl, n-butyl, tert-butyl, n-pentyl, and/or phenyl.

R³ is preferably methylene, ethylene, n-propylene, isopropylene, n-butylene, tert-butylene, n-pentylene, n-octylene, or n-dodecylene.

Another preferred meaning of R³ is phenylene or naphthylene.

Suitable phosphinates have been described in PCT/WO 97/39053, expressly incorporated herein by way of reference.

Preferred phosphinates are phosphinates of aluminum, of calcium, and of zinc.

Preferred hypophosphites are calcium hypophosphite, zinc hypophosphite and aluminum hypophosphite.

Component B preferably comprises condensation products of melamine.

The condensation products of melamine preferably comprise melem, melam, melon and/or compounds thereof having higher condensation level.

Component B preferably comprises reaction products of melamine with polyphosphoric acid, and/or comprises reaction products of condensation products of melamine with polyphosphoric acid, or comprises a mixtures of these.

The reaction products preferably comprise dimelamine pyrophosphate, melamine polyphosphate, melem polyphosphate, melam polyphosphate, melon polyphosphate, and/or mixed polysalts of this type.

Component B particularly preferably comprises melamine polyphosphate.

The nanofillers preferably comprise organically intercalated phyllosilicates. The starting material used for the organically intercalated phyllosilicates preferably comprises swellable smectites, such as montmorillonite, hectorite, saponite, or beidellite.

The organically intercalated phyllosilicates have a distance of from 1.5 to 4 nm between the layers. The phyllosilicates have preferably been intercalated using quatemary ammonium compounds, protonated amines, organic phosphonium ions, and/or aminocarboxylic acids.

The invention also provides a flame-retardant plastics molding composition which comprises the inventive flame retardant-nanofiller combination.

The plastic preferably comprises thermoplastic polymers of the type represented by HI (high-impact) polystyrene, polyphenylene ethers, polyamides, polyesters, polycarbonates, and blends or polyblends of the type represented by ABS (acrylonitrile-butadiene-styrene) or PC/ABS (polycarbonate/acrylonitrile-butadiene-styrene), or PPE/HIPS (polyphenylene ether/HI polystyrene) plastics.

The plastic particularly preferably comprises polyamides, polyesters and PPE/HIPS blends.

It is preferable that in the plastics molding composition the amount of component A is from 2 to 20% by weight, the amount used of component B is from 1 to 30% by weight, and the amount used of component C is from 0.05 to 5% by weight, based on the plastics molding composition.

It is particularly preferable that in the plastics molding composition the amount of component A is from 5 to 10% by weight, the amount used of component B is from 5 to 10% by weight and the amount used of component C is from 0.05 to 5% by weight, based on the plastics molding composition.

In another embodiment of the plastics molding composition, the amount of component A is from 2 to 20% by weight and the amount used of component C is from 0.05 to 5% by weight, based on the plastics molding composition.

Finally, the invention also provides polymer moldings, polymer films, polymer filaments, and polymer fibers which comprise the inventive flame retardant-nanofiller combination.

The polymer moldings, polymer films, polymer filaments, and polymer fibers preferably comprise Hi (high-impact) polystyrene, polyphenylene ethers, polyamides, polyesters, polycarbonates, and blends or polyblends of the type represented by ABS (acrylonitrile-butadiene-styrene), or PC/ABS (polycarbonate/acrylonitrile-butadiene-styrene).

It is preferable that the polymer moldings, polymer films, polymer filaments, and polymer fibers comprise an amount of from 2 to 20% by weight of component A, an amount of from 1 to 30% by weight of component B, and an amount of from 0.05 to 5% by weight of component C, based on the polymer content.

It is particularly preferable that the polymer moldings, polymer films, polymer filaments, and polymer fibers comprise an amount of from 5 to 10% by weight of component A, an amount of from 5 to 10% by weight of component B, and an amount of from 0.05 to 5% by weight of component C, based on the polymer content.

In another embodiment, the polymer moldings, polymer films, polymer filaments and polymer fibers comprise an amount of from 2 to 20 by weight of component A and an amount of from 0.05 to 5% by weight of component C, based on the polymer content.

Preferred nitrogen-containing flame retardant components are condensation products of melamine and/or condensation products of melamine with phosphoric acid, and/or are reaction products of condensation products of melamine with phosphoric acid, and/or are a mixture of these. Particular preference is given to melamine phosphate, melamine pyrophosphate, or melamine polyphosphate, and also to corresponding phosphates of melam, of melem, or of melon. Ammonium polyphosphate is likewise preferred.

The abovementioned nanofillers may be introduced into the plastic in a very wide variety of steps of the process. For example, in the case of polyamides or polyesters, it is possible to mix the nanofillers into the polymer melt at a juncture as early as the start of the polymerization/polycondensation, or at its end, or in a subsequent compounding process. There are also processes in which the introduction of the additives does not take place until later. This method is used particularly when use is made of pigment masterbatches or of additive masterbatches. It is also possible to apply additives, in particular pulverulent additives, to the cold or warm polymer pellets in a drum mixer.

In particular, it is also possible to incorporate nitrogen compounds of the formulae (III) to (VIII) or a mixture of these

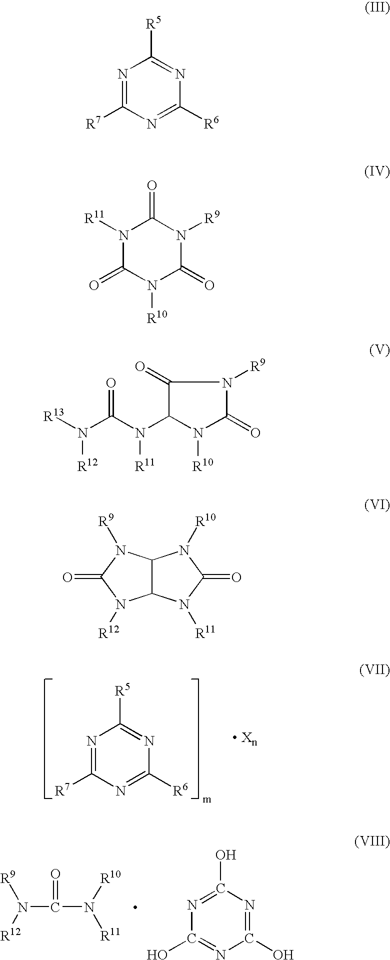

where

R⁵ to R⁷ are hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, C₆-C₁₂-aryl or -arylalkyl, —OR⁸, or —N(R⁸)R⁹, either N-alicyclic or N-aromatic,

R⁸ is hydrogen, C₁-C₈-alkyl, C₅-C₁₆-cycloalkyl or -alkylcycloalkyl, optionally substituted with a hydroxy or a C₁-C₄-hydroxyalkyl function, C₂-C₈-alkenyl, C₁-C₈-alkoxy, -acyl, -acyloxy, or C₆-C₁₂-aryl or -arylalkyl,

R⁹ to R¹³ are the same as the groups for R⁸, or else —O—R⁸,

m and n independently of one another, are 1, 2, 3 or 4,

X is acids which can form adducts with triazine compounds (III).

Carbodiimides may also be present.

The invention also provides synergistic combinations of the phosphinates mentioned with the abovementioned nitrogen-containing compounds, which are more effective flame retardants than the phosphinates alone in many polymers (DE-A-196 14 424, DE-A-197 34 437, and DE-A-197 37 727). The flame-retardant action of the surface-modified phosphinates may be improved by combination with other flame retardants, preferably with nitrogen-containing synergists or phosphorus/nitrogen flame retardants.

The flame retardant mixture preferably comprises from 2 to 20% by weight of phosphinate, from 5 to 30% by weight of nitrogen-containing flame retardant, and from 0.5 to 5% by weight of metal oxide or metal hydroxide, or of mixed oxides/hydroxides, or of oxide hydroxide carbonates, the amounts given being based on the flame-retardant plastic.

The flame retardant mixture particularly preferably comprises from 5 to 10% by weight of phosphinate, from 5 to 10% by weight of nitrogen-containing flame retardant, and from 0.2 to 5% by weight of metal oxide or metal hydroxide, or of mixed oxides/hydroxides, or of oxide hydroxide carbonates, the amounts given being based on the flame-retardant plastic.

The flame retardant mixture is preferably admixed at from 5 to 30% by weight with the polyamides or polyesters, to achieve flame retardancy.

The flame retardant mixture preferably takes the form of pellets, flakes, fine grains, powder, and/or micronisate.

The flame retardant mixture preferably takes the form of a physical mixture of the solids, a melt mixture, a compactate, an extrudate, or a masterbatch.

The mixture is preferably used in a molding composition of a polyamide or of a polyester. Suitable polyamides have been described by way of example in DE-A-199 20 276.

The polyamides preferably comprise those of amino acid type and/or of diamine/ dicarboxylic acid type.

The polyamides preferably comprise nylon-6 and/or nylon-6,6.

The polyamides are preferably unmodified, colored, filled, unfilled, reinforced, unreinforced, or else modified in any other way.

The polyesters preferably comprise polyethylene terephthalate or polybutylene terephthalate.

The polyester are preferably unmodified, colored, filled, unfilled, reinforced, unreinforced, or else modified in any other way.

The total amount of the flame retardant mixture in the polymer is particularly preferably from 5 to 30% by weight.

Where appropriate, other additives may be added to the polymer. Additives which may be added are waxes, light stabilizers, other stabilizers, antioxidants, antistatic agents, or a mixture of these additives. Preferred stabilizers which may be used are phosphonites and phosphites, or carbodiimides.

### EXAMPLES

### 1. Components Used

Commercially available polymers (pellets):

| | |
|---|---|
| nylon-6,6 (GRPA 6.6): | ® Durethan AKV 30 (Bayer AG, |
| | Germany) |
| | comprising 30% of glass fibers. |
| polybutylene terephthalate (GRPBT): | ® Celanex 2300 GV1/30 (Ticona, |
| | Germany) |
| | comprising 30% of glass fibers. |

Flame retardant components (pulverulent):

aluminum salt of diethylphosphinic acid, hereinafter termed DEPAL.

®Melapur 200 (melamine polyphosphate), hereinafter termed MPP, DSM Melapur, Netherlands

Nanofiller:

®Nanofil 919, Sudchemie, Moosburg, Germany Organically modified nanodisperse phyllosilicate with chemical functionality C18 n-alkyl group, white powder

### 2. Preparation, Processing, and Testing of Flame-Retardant Plastics Molding Compositions

The polymers were processed in a twin-screw extruder (Berstorff ZE 25/40) at temperatures of from 260 to 310° C. (GRPA 6.6) or from 240 to 280° C. (GRPBT). The homogenized polymer extrudate was drawn off, cooled in a waterbath, and then pelletized.

The flame retardant components were mixed in the ratio given in the tables with the nanofiller, and added to the polymer melt through a side feed.

After adequate drying, the molding compositions were processed at melt temperatures of from 270 to 320° C. (GRPA 6.6) or from 260 to 280° C. (GRPBT) in an injection-molding machine (Arburg 320° C. Allrounder) to give test specimens, and tested and classified for flame retardancy on the basis of the UL 94 (Underwriters Laboratories) and the IEC 60695-2 glow-wire test.

The flowability of the molding compositions was determined by determining the melt volume index (MVR) at 275° C./2.16 kg. A sharp rise in the MVR value indicates polymer degradation.

Processing properties in polyester were assessed on the basis of specific viscosity (SV). After adequate drying, the pellets of the plastics molding composition were used to prepare a 1.0% strength solution in dichloroacetic acid, and the SV value was determined. The higher the SV value, the less polymer degradation occurred during the incorporation of the flame retardant.

Unless stated otherwise, all of the experiments of a particular series were carried out under identical conditions (temperature profiles, screw geometries, injection-molding parameters, etc.) for reasons of comparability.

Tables 1 and 3 show comparative examples which use a flame retardant combination based on the aluminum salt of diethylphosphinic acid (DEPAL) and on the nitrogen-containing synergist melamine polyphosphate (MPP), and the nanofiller alone.

Tables 2 and 4 list the results of the examples in which the flame retardant-nanofiller mixture of the invention was used. All of the amounts are stated in % by weight, and are based on the plastics molding composition inclusive of the flame retardant combination and of additives.

The examples show that the inventive additions (mixture of the components phosphinate, nitrogen-synergist, and nanofiller) gives improvements in flame-retardant action and in processing.

The incorporation of the flame retardants in PA 6.6 results in polymer degradation, detectable in high MVR values, and grayish-brown discoloration of the molding compositions ((comparative) examples 2-4). The glow-wire ignition temperature (GWIT to IEC 60695-1-13) which can be achieved is only 700° C. Flame retardancy cannot be achieved by adding nanofiller alone ((comparative) examples 5-8).

If use is then made of an inventive flame retardant-nanofiller mixture composed of phosphinate, nitrogen synergist, and nanofiller (inventive examples 9-12), marked stabilization of the flame-retardant polyamide melt can be observed, together with a substantial reduction in discoloration of the test specimens. In addition, the glow-wire ignition temperature now found is above 800° C.

The incorporation of the flame retardants into polyester (PBT) results in polymer degradation by both DEPAL and melamine polyphosphate, detectable in a reduction in the SV value and yellow discoloration. The combination of DEPAL and melamine polyphosphate results in a V-0 classification at 15% by weight of flame retardant. However, the glow-wire ignition temperature is only at most 700° C., similar to that for polyamide. Nanofillers alone exhibit almost no flame-retardant action (Table 3).

When the inventive combination of phosphinate, nitrogen synergist and nanofiller was used in the flame-retardant polyester (PBT), markedly less polymer degradation was observed, detectable in high SV values, together with markedly less discoloration (Table 4). In addition, the glow-wire ignition temperature then found is above 800° C.

Unless otherwise stated, the amounts stated are always in % by weight.

TABLE 1
Comparative examples (experimental series 1): Flame-retardant
molding compositions using the components as individual additives in
glass-fiber-reinforced PA 6.6.

| | | | | | GWIT/IEC | | |
|---|---|---|---|---|---|---|---|
| | DEPAL | MPP | | UL 94 (0.8 mm) | 60695-2-13 | MVR | |
| Comparison | [%] | [%] | Nanofill 919 | classification | [° C.] | [cm³/10′] | Color* |
| 1 | 0 | 0 | 0 | n.c.**⁾ | 550 | 19 | white |
| 2 | 10 | 5 | 0 | V-0 | 700 | 44 | grayish |
| | | | | | | | brown |
| 3 | 0 | 10 | 0 | n.c. | 650 | 55 | gray |
| 4 | 10 | 0 | 0 | V-2 | 650 | 20 | brown |
| 5 | 0 | 0 | 1 | n.c. | 550 | 21 | white |
| 6 | 0 | 0 | 2 | n.c. | 550 | 21 | white |
| 7 | 0 | 0 | 5 | n.c. | 600 | 21 | white |
| 8 | 0 | 0 | 10 | V-2 | 650 | 21 | white |

*of test specimen, melt temperature during injection molding: 300° C.
**⁾n.c. = not classifiable

TABLE 2
Inventive examples: flame-retardant molding compositions using the
combination of DEPAL with nitrogen synergist and metal oxide or
hydroxide in glass-fiber-reinforced PA 6.6.

| | | | Nanofil | | GWIT/IEC | | |
|---|---|---|---|---|---|---|---|
| Examples | DEPAL | MPP | 919 | UL 94 (0.8 mm) | 60695-2-13 | MVR | |
| (invention) | [%] | [%] | [%] | classification | [° C.] | [cm³/10′] | Color* |
| 9 | 10 | 5 | 2 | V-0 | 750 | 19 | white |
| 10 | 10 | 5 | 5 | V-0 | 800 | 17 | white |
| 11 | 8 | 4 | 2 | V-0 | 750 | 21 | white |
| 12 | 5 | 5 | 5 | V-0 | 750 | 22 | white |

*of test specimen, melt temperature during injection molding: 300° C.

TABLE 3
Comparative examples: Flame-retardant molding compositions using
the components as individual additives in glass-fiber-reinforced PBT

| | | | | | GWIT/IEC | | |
|---|---|---|---|---|---|---|---|
| | DEPAL | MPP | Nanofill | UL 94 (0.8 mm) | 60695-2-13 | | |
| Comparison | [%] | [%] | 919 | classification | [° C.] | SV value | Color* |
| 13 | 0 | 0 | 0 | n.c.**⁾ | 550 | 1200 | white |
| 14 | 10 | 5 | 0 | V-0 | 700 | 744 | white |
| 15 | 0 | 10 | 0 | n.c. | 650 | 1134 | white |
| 16 | 10 | 0 | 0 | V-2 | 650 | 643 | white |
| 17 | 0 | 0 | 2 | n.c. | 550 | 1251 | white |
| 18 | 0 | 0 | 5 | n.c. | 550 | 1238 | white |

*of test specimen, melt temperature during injection molding: 275° C.

TABLE 4
Inventive examples: flame-retardant molding compositions using the
combination of DEPAL with nitrogen synergist and nanofiller in
glass-fiber-reinforced PBT

| | | | | | GWIT/IEC | | |
|---|---|---|---|---|---|---|---|
| Examples | DEPAL | MPP | Nanofil | UL 94 (0.8 mm) | 60695- | | |
| (invention) | [%] | [%] | 919 [%] | classification | 2-13 [° C.] | SV value | Color* |
| 19 | 10 | 5 | 2 | V-0 | 750 | 1213 | white |
| 20 | 10 | 5 | 5 | V-0 | 800 | 1289 | white |
| 21 | 8 | 4 | 2 | V-0 | 750 | 1199 | white |
| 22 | 5 | 5 | 5 | V-1 | 750 | 1168 | white |

*of test specimen, melt temperature during injection molding: 275° C.

1. A flame retardant-nanofiller combination for a thermoplastic polymer comprising, as component A, a phosphinic salt of the formula (I), a diphosphinic salt of the formula (II) a polymer of a phosphinic salt of the formula (I), a polymer of a diphosphinic salt of the formula (II) or mixtures thereof, 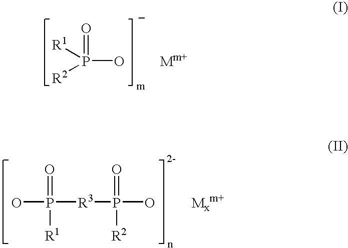
where
R¹, R² are identical or different and are C₁-C₆-alkyl, linear or branched, or aryl;
R³ is C₁-C₁₀-alkylene, linear or branched, C₆-C₁₀-arylene, -alkylarylene or -arylalkylene;
M is Al, Sb, Sn, Ge, Ti, Zn, Fe, Zr, Ce, Bi or Mn;
m is 1 to 4;
n is 1 to 4;
x is1 to 4,
and at least one of component B and component C, wherein component B, is selected from the group consisting of condensation products of melamine, reaction products of melamine with phosphoric acid or polyphosphoric acid, reaction products of condensation products of melamine with phosphoric acid or polyphosphoric acid, and mixtures thereof, wherein component C, is selected from the group consisting of organic intercalated phyllosilicates, nanospherical oxides, and carbon nanotubes.

2. The flame retardant-nanofiller combination as claimed in claim 1, wherein R¹ and R² are identical or different and are C₁-C₆-alkyl, linear or branched, or phenyl.

3. The flame retardant-nanofiller combination as claimed in claim 1, wherein R¹ and R² are identical or different and are methyl, ethyl, n-propyl, isopropyl, n-butyl, tert-butyl, n-pentyl or phenyl.

4. The flame retardant-nanofiller combination as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethyinaphthylene, tert-butylnaphthylene; phenylmethylene, phenylethylene, phenylpropylene, or phenylbutylene.

5. The flame retardant-nanofiller combination as claimed in claim 1, wherein M is calcium ions, aluminum ions, or zinc ions.

6. The flame retardant-nanofiller combination as claimed in claim 1, wherein component B is the condensation products of melamine.

7. The flame retardant-nanofiller combination as claimed in claim 6, wherein the condensation products of melamine are selected from the group consisting of melem, melam, melon and compounds thereof having higher condensation levels.

8. The flame retardant-nanofiller combination as claimed in claim 1, wherein component B is the reaction products of melamine with polyphosphoric acid, the reaction products of condensation products of melamine with polyphosphoric acid, or a mixture thereof.

9. The flame retardant-nanofiller combination as claimed in claim 1, wherein component B is selected from the group consisting of dimelamine pyrophosphate, melamine polyphosphate, melem polyphosphate, melam polyphosphate, melon polyphosphate, mixed polysalts thereof and mixtures thereof.

10. The flame retardant-nanofiller combination as claimed in claim 1, wherein component B comprises melamine polyphosphate.

11. The flame retardant-nanofiller combination as claimed in claim 1, wherein the organic intercalated phyllosilicates comprise materials for which the starting materials are swellable smectites, or beidellite.

12. The flame retardant-nanofiller combination as claimed in claim 1, wherein the organic intercalated phyllosilicates have been intercalated using quatemary ammonium compounds, protonated amines, organic phosphonium ions, aminocarboxylic acids, and mixtures thereof.

13. A flame-retardant plastic molding composition comprising a flame retardant-nanofiller combination as claimed in claim 1.

14. The flame-retardant plastic molding composition as claimed in claim 13, wherein the plastic is a thermoplastic polymer selected from the group consisting of HI (high-impact) polystyrene, polyphenylene ethers, polyamides, polyesters, polycarbonates, and blends or polyblends of the type represented by ABS (acrylonitrile-butadiene-styrene), ePC/ABS (polycarbonate/acrylonitrile-butadiene-styrene), or PPE/HIPS (polyphenylene ether/HI polystyrene) plastics.

15. The flame-retardant plastic molding composition as claimed in claim 13, wherein the plastic is selected from the group consisting of polyamides, polyesters and PPE/HIPS blends.

16. The flame-retardant plastic molding composition as claimed in one or more of claims 13, wherein component A is present from 2 to 20% by weight, component B from 1 to 30% by weight, and component C from 0.05 to 20% by weight, based on the plastic molding composition.

17. The flame-retardant plastic molding composition as claimed in claim 13, wherein component A is present from 5 to 10% by weight, component B from 5 to 10% by weight, and the amount used of component C from 0.05 to 10% by weight, based on the plastic molding composition.

18. The flame-retardant plastic molding composition as claimed in claim 13, wherein component A is present from 2 to 20% by weight and component C from 0.05 to 5% by weight, based on the plastic molding composition.

19. A polymeric article comprising a flame retardant-nanofiller combination as claimed in claim 1, wherein the polymeric article is selected from the group consisting of a polymer molding, film, filament and fiber.

20. The polymeric article as claimed in claim 19, wherein the polymer comprises HI (high-impact) polystyrene, polyphenylene ethers, polyamides, polyesters, polycarbonates, and blends or polyblends of the type represented by ABS (acrylonitrile-butadiene-styrene), or PC/ABS (polycarbonate/acrylonitrile-butadiene-styrene).

21. The polymeric article as claimed in claim 19, wherein component A is present from 2 to 20% by weight, component B from 1 to 30% by weight, and component C from 0.5 to 20% by weight, based on the polymer content.

22. The polymeric article as claimed in claim 19, component A is present from 5 to 10% by weight, component B from 5 to 10% by weight, and the amount of component C from 0.5 to 10% by weight, based on the polymer content.

23. The polymeric article as claimed in claim 19, wherein component A is present from 2 to 20% by weight and component C from 0.5 to 5% by weight, based on the polymer content.

24. The flame retardant-nanofiller combination as claimed in claim 11, wherein the swellable smectites are selected from the group consisting of montmorillonite, hectorite, saponite or beidellite.
